(19) United States
(12) Patent Application Publication
(10) Pub. No.: US 2020/0034152 A1
(43) Pub. Date: Jan. 30, 2020

(54) Preventing Information Leakage In Out-Of-Order Machines Due To Misspeculation

(71) Applicant: Cavium, LLC, Santa Clara, CA (US)

(72) Inventors: David A. Carlson, Haslet, TX (US); Shubhendu S. Mukherjee, Southborough, MA (US)

(21) Appl. No.: 16/049,314

(22) Filed: Jul. 30, 2018

(51) Int. Cl. G06F 9/38; G06F 9/30; G06F 12/0875

(52) U.S. Cl. CPC G06F 9/3855; G06F 9/30043; G06F 2212/452; G06F 9/3806; G06F 12/0875

(57) ABSTRACT

Typical out-of-order machines can be exploited by security vulnerabilities, such as Meltdown and Spectre, that enable data leakage during misspeculation events. A method of preventing such information leakage includes storing information regarding multiple states of an out-of-order machine to a reorder buffer. This information includes the state of instructions, as well as an indication of data moved to a cache in the transition between states. In response to detecting a misspeculation event at a later state, access to at least a portion of the cache storing the data can be prevented.

### BACKGROUND

Central processing units (CPUs), such as those found in network processors and other computing systems, often implement out-of-order execution to complete work. In out-of-order execution, a processor executes instructions in an order based on the availability of input data and execution units, rather than by their original order in a program. As a result, the processor can avoid being idle while waiting for the preceding instruction to complete and can, in the meantime, process the next available instructions independently. The processor may also implement branch prediction, whereby the processor performs a speculative execution based on the data immediately available. If the speculation is validated, the results are immediately available, increasing the speed of the execution. Otherwise, incorrect results are discarded.

Typical out-of-order machines can be exploited by security vulnerabilities inherent in some misspeculation events. During a speculative execution, data may be loaded into a cache, where it can remain after the speculation is determined to be incorrect. An attacker can then implement additional code to access this data. Spectre and Meltdown are the names given to two security vulnerabilities that can be exploited in this manner.

### SUMMARY

Example embodiments include a method of managing an out-of-order machine to prevent leakage of information following a misspeculation event. Information regarding a first state of the out-of-order machine is stored to a reorder buffer. The information can indicate a state of one or more registers, location of data, and/or the state of scheduled, pending and/or completed instructions. When the machine progresses to a second state (e.g., during or after a speculation operation), information regarding the second state may be stored to the reorder buffer. This information indicates whether data is moved to a cache during transition from the first state to the second state. In response to detecting a misspeculation event of the second state, access is prevented to at least a portion of the cache storing the data.

In further embodiments, preventing access may include invalidating the at least a portion of the cache storing the data, and/or invalidating an entirety of the cache. The cache may include a d-cache, a branch target cache, a branch target buffer, a store-load dependence predictor, an instruction cache, a translation buffer, a second level cache, a last level cache, and a DRAM cache. In response to detecting the misspeculation event, a branch predictor, a branch target cache, a branch target buffer, a store-load dependence predictor, an instruction cache, a translation buffer, a second level cache, a last level cache, and/or a DRAM cache may be invalidated.

The information regarding the first and second states may include the locations of cache blocks storing the data, as well as an indication of cache blocks created during execution of one or more operations associated with the misspeculation event. Based on the information regarding the second state, cache blocks created during execution of operations associated with the misspeculation event may be identified. The misspeculation event may occur during a load/store operation executed by the machine. The first state may correspond to a state of the machine prior to execution of the load/store operation, and the second state may correspond to a state of the machine after the execution of the load/store operation.

Further embodiments may include an out-of-order machine comprising a cache, a processor configured to execute an instruction, a reorder buffer, and a controller. The controller may be configured to 1) store information regarding a first state of the out-of-order machine to the reorder buffer prior to execution of the instruction; 2) store information regarding a second state of the out-of-order machine to the reorder buffer following execution of the instruction, the information indicating whether data is moved to the cache between the first and second states; and 3) in response to detecting a misspeculation event of the second state, prevent access to at least a portion of the cache storing the data.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an out-of-order machine in an example embodiment.

FIG. 2 is a block diagram of a reorder buffer in one embodiment.

FIG. 3 is a flow diagram of a process of managing an out-of-order machine in one embodiment.

FIG. 4 illustrates a computer network or similar digital processing environment in which example embodiments may be implemented.

FIG. 5 is a diagram of an example internal structure of a computer in which example embodiments may be implemented.

### DETAILED DESCRIPTION

Example embodiments are described in detail below. Such embodiments may be implemented in any suitable computer processor, particularly out-of-order machines such as a network services processor or a modern central processing unit (CPU).

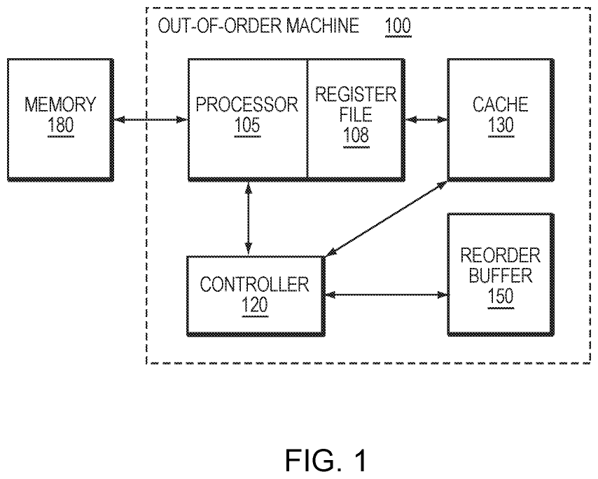

FIG. 1 is a block diagram of an out-of-order machine 100 in an example embodiment. The machine 100 may be implemented as one or more of the cores of a multi-core computer processor, while the memory 180 may encompass an L2 cache, DRAM, and/or any other memory unit accessible to the machine 100. For clarity, only a relevant subset of the components of the machine 100 are shown.

The machine 100 includes a processor 105, a register file 108, a cache 130, a controller 120, and a reorder buffer 150. The processor 105 may perform work in response to received instructions and, in doing so, manage the register file 108 as a temporary store of associated values. The processor 105 also accesses the cache 130 to load and store data associated with the work. The cache 130 may include one or more distinct caches, such as a d-cache, a branch target cache, a branch target buffer, a store-load dependence predictor, an instruction cache, a translation buffer, a second level cache, a last level cache, and a DRAM cache, and can include caches located on-chip and/or off-chip.

The controller 120 manages the reorder buffer 150 to track the status of instructions assigned to the processor 105. The reorder buffer 150 stores information about the instructions, as well as the order(s) in which the corresponding work product is to be reported. As a result, the processor 105 can execute instructions in an order that maximizes efficiency independent of the order in which the instructions were received, while the reorder buffer 150 enables the work product to be presented in a required order.

In order to improve the speed and efficiency of execution, the processor 105 may perform branch prediction. When the processor 105 does not have immediate access to all data needed to execute an instruction, it may perform a speculative execution based on the data immediately available to it. If the speculation is validated once the missing data is received, the results are immediately available. Otherwise, incorrect results, produced by a misspeculation, can be discarded.

Typical out-of-order machines can be exploited by security vulnerabilities, such as the vulnerabilities known as Spectre and Meltdown. Those vulnerabilities can occur as a result of a misspeculation. During a speculative execution, data may be loaded into a cache, where it can remain after the speculation is determined to be incorrect. An attacker can then implement additional code to access this data. For example, an incorrect speculation due to a branch prediction, jump prediction, ordering violation, or exception may occur as a result of instructions such as the following:

LD a, [ptr]

LD b, [a*k]

When executed by the processor 105, the first instruction is a load instruction that will access a piece of memory the attacker wants knowledge of. The second instruction is a load instruction that will use the result of the first to compute an address. The second load instruction will cause the memory system to move the memory contents pointed to by the load (e.g., in the memory 180) into the cache 130 (e.g., a d-cache). At some point afterwards, the processor 105 determines that the speculation event was incorrect. In response, the processor 105 will reference the record stored to the reorder buffer 150 to back the machine up, restoring its architectural state to its condition prior to the speculation. In typical machines, the fact that a cache block got loaded into the cache 130 will remain, and the attacker can employ certain calculations to determine which block was loaded. If the attacker knows which block was loaded, the attacker may be able to discern the content of the block. This attack takes advantage of the fact that, in typical out-of-order machines, the location of data in the memory hierarchy is not considered an architectural state.

Example embodiments can prevent access to information moved as a result of a misspeculation, thereby preventing vulnerability to attacks such as the attack described above. In one embodiment, the controller 120 may track and associate cache blocks that are moved into the cache 130 with the load/store that incorrectly executed due to misspeculation, storing information regarding those moves to the reorder buffer 150. When the machine 100 detects a misspeculation event, the machine may invalidate some or all cache blocks from the cache 130 that were created while executing down the incorrect path. Further embodiments may also manage a translation lookaside buffer (TLB), second level data cache, an instruction cache, or another data store in the same manner.

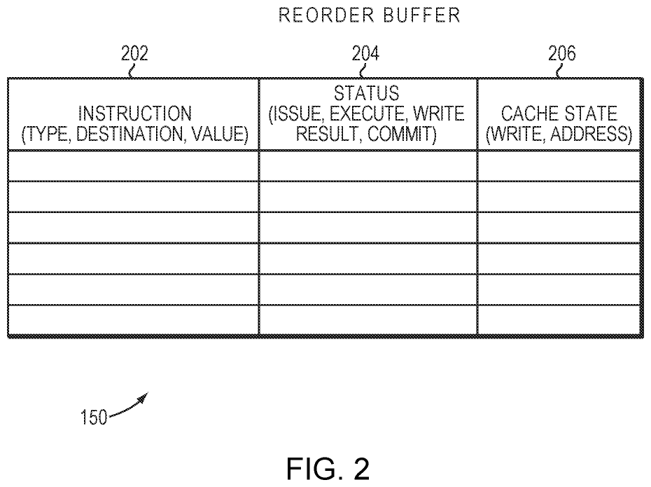

FIG. 2 is a block diagram of the reorder buffer 150 in an example embodiment. A first column 202 stores entries identifying each of the instructions assigned to the processor 105, and may include information such as instruction type, instruction destination, and instruction value (e.g., an instruction identifier). A second column 204 stores entries indicating the status of each of those instructions (e.g., issue, execute, write result, commit). A third column 206 includes entries providing information on any data that is moved in the process of executing the associated instruction. For example, the third column 206 may store identifiers for the data itself, an identifier of the origin of the data (e.g., an identifier of the memory device or an address of the memory, such as the memory 180), and/or an identifier of the destination of the data (e.g., an identifier of the particular cache receiving the data, and/or an address of the relevant block of the cache 130).

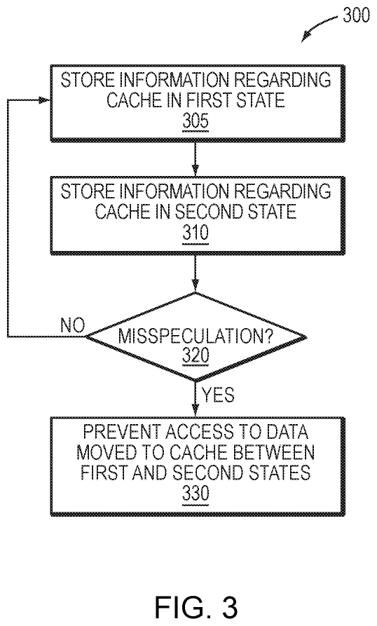

FIG. 3 is a flow diagram of a process 300 of managing an out-of-order machine in one embodiment. With reference to FIGS. 1 and 2, while the processor 150 is executing instructions, the controller 120 may continually update the reorder buffer 150 to maintain a current status of those instructions. In a first state of the machine 100, prior to a speculative execution, the controller 120 may store information regarding the cache 130 to the reorder buffer 150 (e.g., at column 206) (305). As the machine 100 enters a second state reflecting the execution of the predictive branch, the controller 120 updates the reorder buffer 150 to indicate and identify any data that was moved into the cache 130 during the execution (310). If the speculation is validated, the process may be repeated for further executions. If, however, the machine determines that the speculation is incorrect and reports a misspeculation event (320), then the controller 120, referencing the reorder buffer 150, may undergo operations to prevent access to the data moved to the cache 130 between the first and second states (330). For example, the controller 120 may invalidate the portion of the cache 130 storing the data according to the address indicated in the reorder buffer 150, or may invalidate a larger subset or the entirety of the cache 130. Invalidation may be done, for example, by clearing a “valid” bit corresponding to the data, or by changing the tag portion of the cache structure. As a result, the information moved during the misspeculation cannot be accessed.

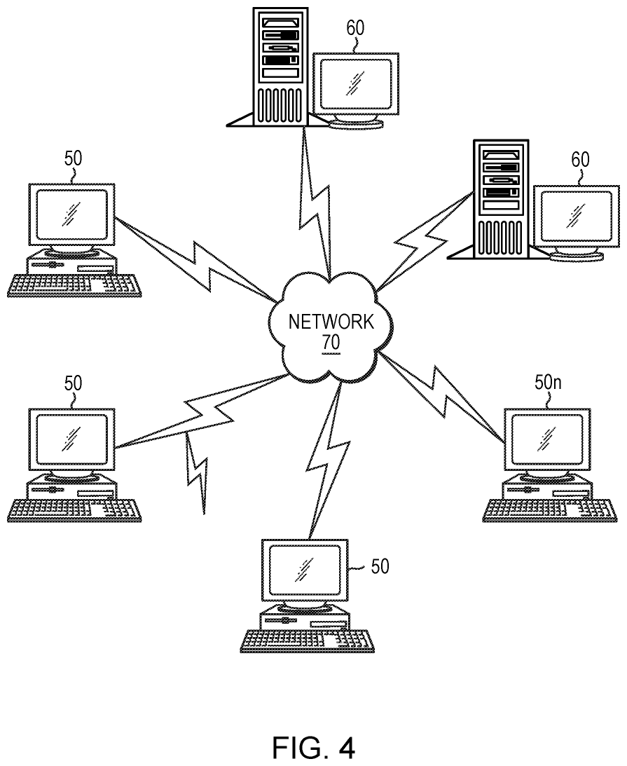

FIG. 4 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client computer(s)/devices 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

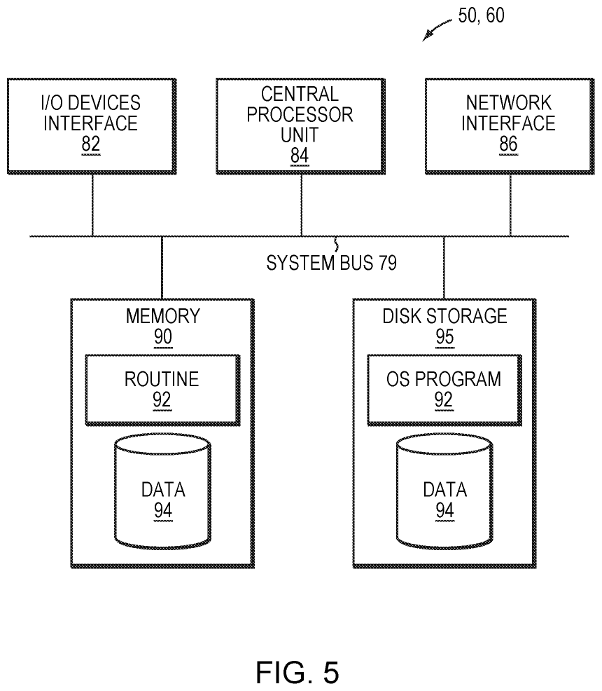

FIG. 5 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., structure generation module, computation module, and combination module code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 may include a computer program product (generally referenced 92), including a non-transitory computer-readable medium (e.g., a removable storage medium) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

While example embodiments have been particularly shown and described, it will be understood by those skilled in the art that various changes in form and details may be made therein without departing from the scope of the embodiments encompassed by the appended claims.

What is claimed is:

1. A method, comprising:
storing information regarding a first state of an out-of-order machine to a reorder buffer, the information indicating a state of at least one register;
storing information regarding a second state of the out-of-order machine to the reorder buffer, the information indicating whether data is moved to a cache during transition from the first state to the second state; and
in response to detecting a misspeculation event of the second state, preventing access to at least a portion of the cache storing the data.

2. The method of claim 1, wherein the preventing access includes invalidating the at least a portion of the cache storing the data.

3. The method of claim 1, wherein the preventing access includes invalidating an entirety of the cache.

4. The method of claim 1, wherein the cache includes a d-cache.

5. The method of claim 1, wherein the cache includes at least one of a branch target cache, a branch target buffer, a store-load dependence predictor, an instruction cache, a translation buffer, a second level cache, a last level cache, and a DRAM cache.

6. The method of claim 1, further comprising, in response to detecting the misspeculation event, invalidating at least one of a branch predictor, a branch target cache, a branch target buffer, a store-load dependence predictor, an instruction cache, a translation buffer, a second level cache, a last level cache, and a DRAM cache.

7. The method of claim 1, wherein the information regarding the second state includes an indication of a location of cache blocks storing the data.

8. The method of claim 1, wherein the information regarding the second state includes an indication of cache blocks created during execution of one or more operations associated with the misspeculation event.

9. The method of claim 1, further comprising identifying, based on the information regarding the second state, cache blocks created during execution of operations associated with the misspeculation event.

10. The method of claim 1, wherein the misspeculation event occurs during a load/store operation executed by the machine.

11. The method of claim 10, wherein the first state corresponds to a state of the machine prior to execution of the load/store operation, and wherein the second state corresponds to a state of the machine after the execution of the load/store operation.

12. An out-of-order machine comprising:
a cache;
a processor configured to execute an instruction;
a reorder buffer; and
a controller configured to:
store information regarding a first state of the out-of-order machine to the reorder buffer prior to execution of the instruction;
store information regarding a second state of the out-of-order machine to the reorder buffer following execution of the instruction, the information indicating whether data is moved to the cache between the first and second states; and
in response to detecting a misspeculation event of the second state, prevent access to at least a portion of the cache storing the data.

13. The machine of claim 12, wherein the controller is further configured to prevent access by invalidating the at least a portion of the cache storing the data.

14. The machine of claim 12, wherein the controller is further configured to prevent access by invalidating an entirety of the cache.

15. The machine of claim 12, wherein the cache includes a d-cache.

16. The machine of claim 12, wherein the cache includes at least one of a branch target cache, a branch target buffer, a store-load dependence predictor, an instruction cache, a translation buffer, a second level cache, a last level cache, and a DRAM cache.

17. The machine of claim 12, wherein the controller is further configured, in response to detecting the misspeculation event, to invalidate at least one of a branch predictor, a branch target cache, a branch target buffer, a store-load dependence predictor, an instruction cache, a translation buffer, a second level cache, a last level cache, and a DRAM cache.

18. The machine of claim 12, wherein the information regarding the second state includes an indication of a location of cache blocks storing the data.

19. The machine of claim 12, wherein the information regarding the second state includes an indication of cache blocks created during execution of one or more operations associated with the misspeculation event.

20. The machine of claim 12, wherein the controller is further configured to identify, based on the information regarding the second state, cache blocks created during execution of operations associated with the misspeculation event.

21. The machine of claim 12, wherein the misspeculation event occurs during a load/store operation executed by the machine.

22. The machine of claim 20, wherein the first state corresponds to a state of the machine prior to execution of the load/store operation, and wherein the second state corresponds to a state of the machine after the execution of the load/store operation.
